(19) United States
(12) Patent Application Publication
(10) Pub. No.: US 2016/0313772 A1
(43) Pub. Date: Oct. 27, 2016

(54) KEYBOARD AND ELECTRONIC DEVICE WITH THE SAME

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: YONG-CHANG FAN, Wuhan (CN); SAN-YONG YANG, Wuhan (CN)

(21) Appl. No.: 14/716,606

(22) Filed: May 19, 2015

(30) Foreign Application Priority Data
Apr. 24, 2015 (CN) 201510199346.3

(51) Int. Cl. G06F 1/18; G06F 1/16

(52) U.S. Cl. CPC G06F 1/189; G06F 1/1658; G06F 1/1669; G06F 1/185

(57) ABSTRACT

A keyboard includes a main body. The main body includes an operating panel used to input commands to an electronic device and a switch located on the operating panel. The main body is used to couple to a motherboard of the electronic device, and the switch is used to power on/off the electronic device when the main body is coupled to the motherboard. The disclosure further offers an electronic device with the keyboard.

### FIELD

The subject matter herein generally relates to a keyboard and an electronic device with the keyboard.

### BACKGROUND

Electronic devices such as personal computers, cellular phones, and personal digital assistants (PDA), etc., are supplied with a keyboard (keyboard unit) having multiple operating keys. The keyboard is typically connected to a casing, which usually includes a power switch. The power switch can power on/off the electronic device.

### BRIEF DESCRIPTION OF THE DRAWINGS

Implementations of the present technology will now be described, by way of example only, with reference to the attached figures.

FIG. 1 is an exploded, isometric view of an embodiment of an electronic device.

FIG. 2 is an isometric view of an expansion card of the electronic device of FIG. 1.

FIG. 3 is an isometric view of an expansion card and a keyboard of the electronic device of FIG. 1.

FIG. 4 is an isometric view of the keyboard of the electronic device of FIG. 1, and a bracket is received in the keyboard.

FIG. 5 is similar to FIG. 4, and the bracket is out of the keyboard.

FIG. 6 is an assembled view of the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to a keyboard and an electronic device with the keyboard. The keyboard includes a main body. The main body includes an operating panel used to input commands to the electronic device and a switch located on the operating panel. The main body is used to couple to a motherboard of the electronic device, and the switch is used to power on/off the electronic device when the main body is coupled to the motherboard.

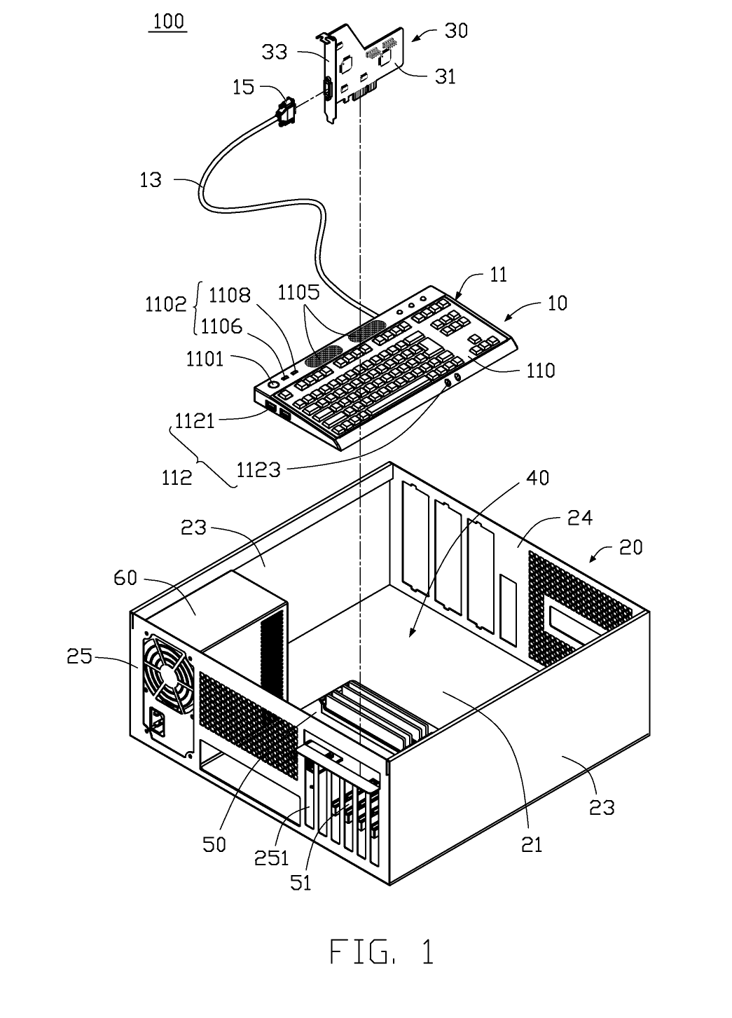

FIGS. 1-3 illustrate an embodiment of an electronic device 100. The electronic device 100 can include a keyboard 10, a case 20, and an expansion card 30. In at least one embodiment, the electronic device 100 can be a personal computer, a cellular phone, and a PDA, etc.

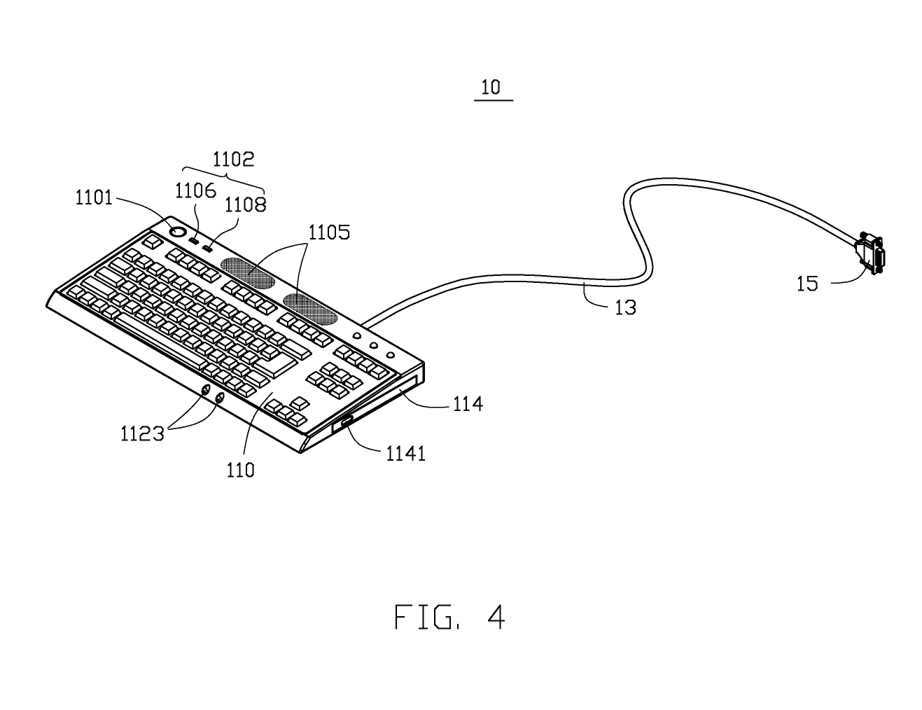

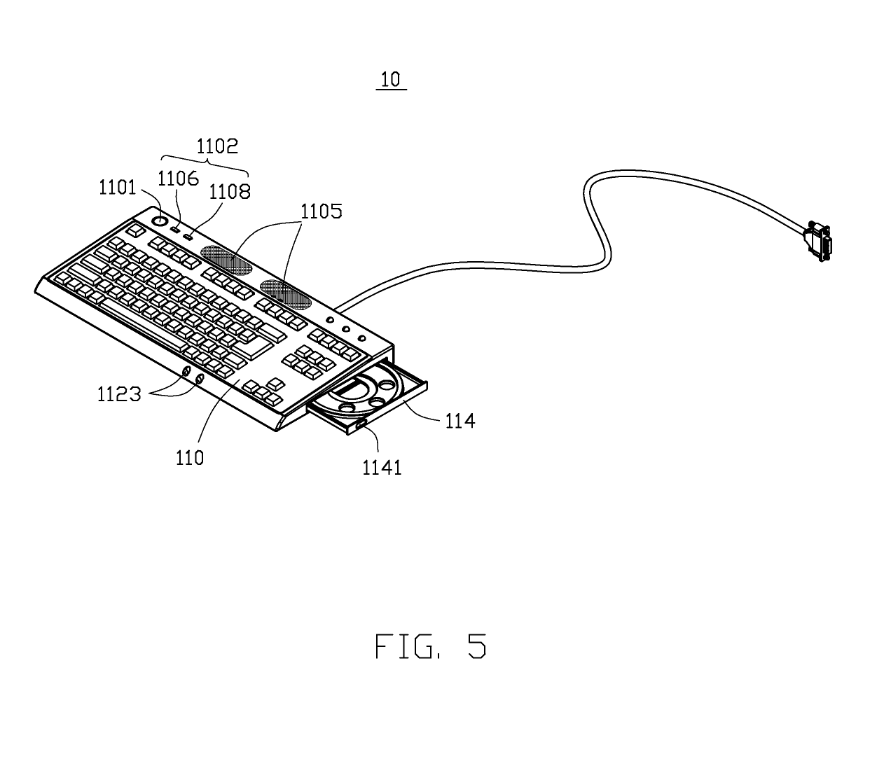

FIGS. 1, 4 and 5 illustrate an embodiment of the keyboard 10 of the electronic device 100. The keyboard 10 can include a main body 11, a cable 13, and a connector 15. The main body 11 can include an operating panel 110 configured to input commands into the electronic device 100, at least one port 112 configured to couple a peripheral device (not shown), and a bracket 114 configured to receive a hard disk (not shown). A plurality of function modules can be located on the operating panel 110. The plurality of function modules can include a switch 1101, two indicators 1102, and two speakers 1102. In at least one embodiment, the switch 1101, the two indicators 1102, and the two speakers 1102 are arranged in a straight line which is substantially parallel to the operating panel 110. The switch 1101 is configured to close or open the electronic device 100. The two indicators 1102 are located between the switch 1101 and the two speakers 1102. In at least one embodiment, the two indicators 1102 can include a power indicator 1106 and a hard disk indicator 1108. The power indicator 1106 is configured to indicate a state of the electronic device 100, and the hard disk indicator 1108 is configured to indicate a state of the hard disk. The speaker 1102 is configured to play an audio document.

The ports 112 can include two Universal Serial Bus (USB) ports 1121 and two audio ports 1123. The two USB ports 1121 are located on a first side portion of the main body 11 and are configured to couple the peripheral device, such as a mouse or a card reader. The two audio ports 1123, configured to couple to an earphone (not shown), are located on the operating panel 110 and opposite to the two speakers 1105.

The bracket 114 is opposite to the two USB ports 1121 and includes a button 1141. The button 1141 is configured to move the bracket 114 relative to the main body 11.

The connector 15 is coupled to the cable 13 and is configured to the expansion card 30.

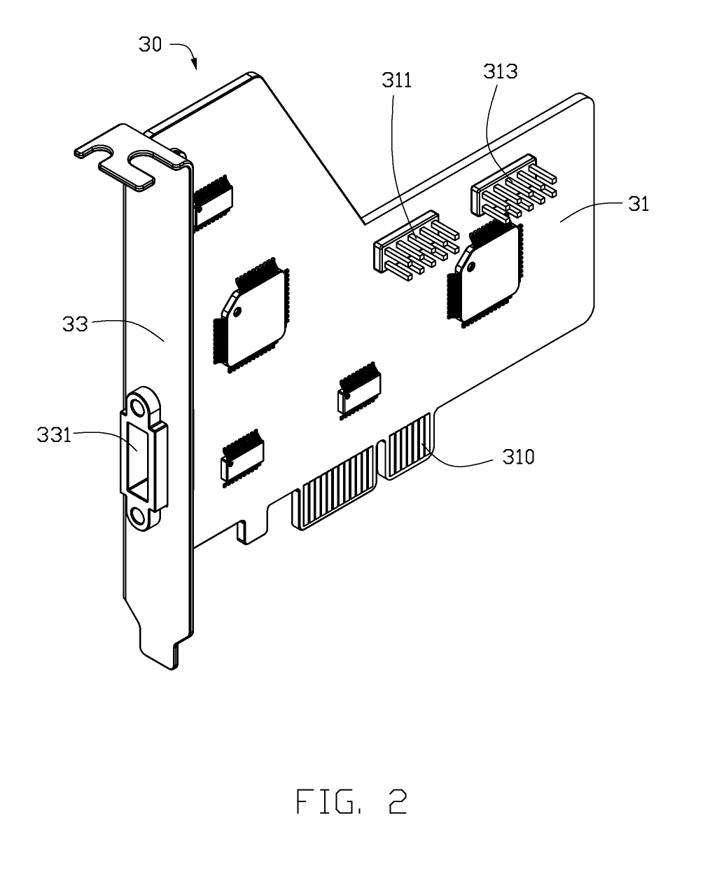

FIGS. 1 and 2 illustrate an embodiment of the case 20 of the electronic device 100. The case 20 can include a bottom plate 21, two opposite side plates 23, a front plate 24 and a rear plate 25. The bottom plate 21, the two opposite side plates 23, the front plate 24 and the rear plate 25 cooperatively define a receiving space 40 for receiving a plurality of electronic components, such as a motherboard 50 and a power supply 60, and so on. The power supply 60 is electronically coupled to the motherboard 50. A plurality of expansion slots 51 is located on the motherboard 50, and a plurality of mounting slots 251 is located on the rear plate 25 for securing the expansion card 30.

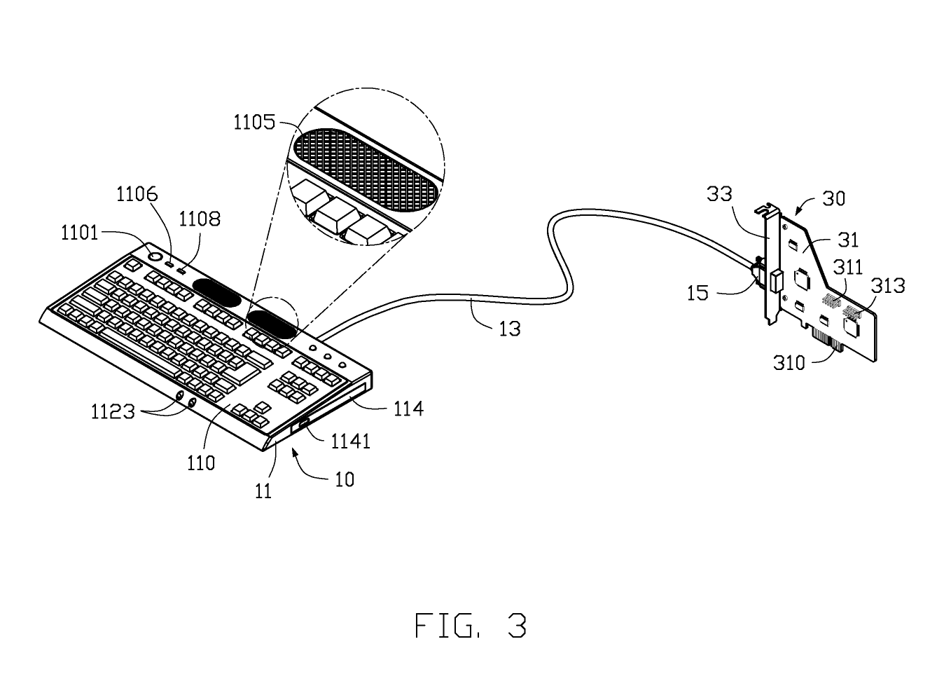

FIGS. 2 and 3 illustrate an embodiment of the expansion card 30 of the electronic device 100. The expansion card 30 can include a base body 31 and a mounting piece 33 located on the base body 31. An inserting portion 310 is located on a bottom portion of the base body 31 and is configured to be engaged in the expansion slot 51, so that the expansion card 30 can be coupled to the motherboard 50. A USB connector 311 and an input/output connector 313 are located on the base body 31, thus, when the keyboard 10 is coupled to the expansion card 30, the keyboard 10 can have a function of the front plate 24. That is, the switch 1101 on the keyboard 10 can power on/off the electronic device 100, and the speakers 1105, the ports 112 and the indicators 1102 are all located on the keyboard 10. A socket 331 is located on the mounting piece 33 and is configured to engage with the connector 15. In at least one embodiment, the mounting piece 33 can be secured to the mounting slot 251 by means, such as jointing, or clips and screws.

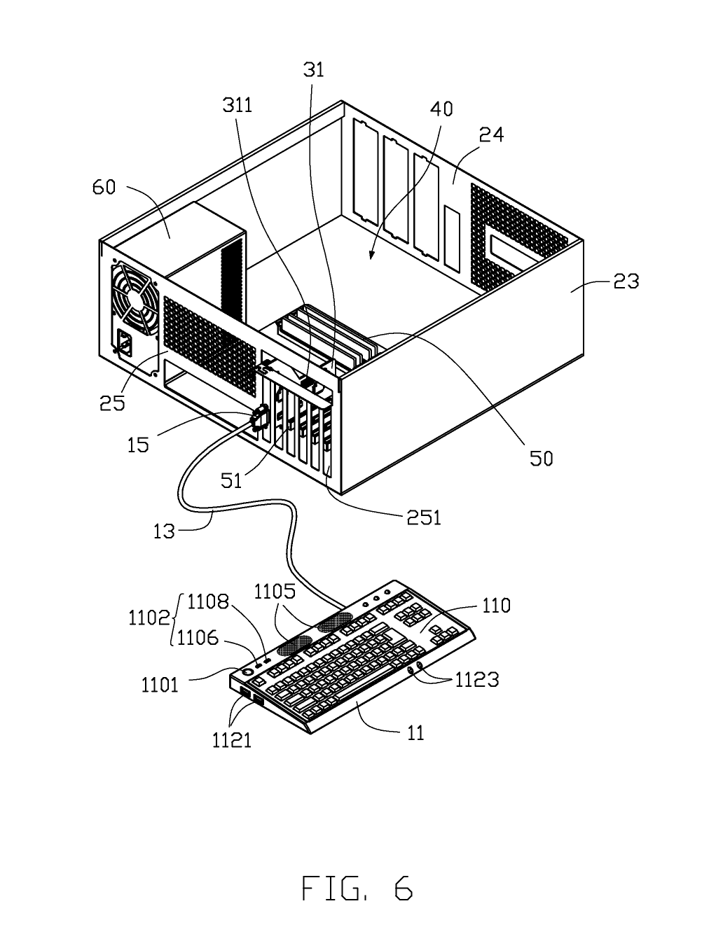

FIGS. 1, 5 and 6 illustrate an assembled view of the electronic device 100. In assembly, the expansion card 30 is located in the receiving space 40, and the inserting portion 310 is engaged with the expansion slot 51. The mounting piece 33 is secured to the mounting slot 251 by means, such as jointing, or clips and screws, so that the expansion card 30 can be secured to the rear plate 25.

In use, the connector 15 is engaged with the socket 331, so that the keyboard 10 is coupled to the motherboard 50 via the expansion card 30. Thus, the switch 1101 can be used to power on/off the power supply 60 of the electronic device 100. The audio document can be listened to through the two speakers 1105 or listened to through the earphone that is engaged in the audio ports 112. The USB ports 1121 can be coupled to the mouse or the card reader. The power indicator 1106 can indicate the state of the electronic device 100, and the hard disk indicator 1108 can indicate the state of the hard disk.

The keyboard 10 can be wirelessly coupled to the motherboard 50. For example, a telemanipulator can be located on the keyboard 10 and is used to power/on the power supply 60.

The embodiments shown and described above are only examples. Many details are often found in the art such as the other features of an electronic device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

1. A keyboard comprising:
a main body comprising an operating panel configured to input commands to an electronic device; and
a bracket configured to receive a hard disk, and the bracket moveably received in the keyboard.

2. The keyboard of claim 1, wherein the keyboard further comprises a speaker configured to play an audio document of the electronic device, and the speaker is located on the operating panel.

3. The keyboard of claim 1, wherein the keyboard further comprises at least one port configured to couple to a peripheral device, and the at least one port is located on the operating panel.

4. The keyboard of claim 3, wherein the at least one port is a Universal Serial Bus port or an audio port.

5. The keyboard of claim 1, wherein the keyboard further comprises a switch located on the operating panel, the main body coupled to a motherboard of the electronic device, and the switch being configured to power on or power off the electronic device in event that the main body is coupled to or uncoupled from the motherboard.

6. The keyboard of claim 1, wherein the keyboard further comprises a hard disk indicator, and the hard disk indicator is configured to indicate a state of the hard disk.

7. The keyboard of claim 5, wherein the keyboard further comprises a power indicator, and the power indicator is configured to indicate a state of a power supply of the electronic device.

8. An electronic device comprising:
a keyboard comprising a main body and a bracket, the main body comprising an operating panel and a switch located on the operating panel; and
a case comprising a receiving space, a motherboard, a power supply and an expansion card located in the receiving space; the power supply and the expansion card coupled to the motherboard;
wherein the keyboard is coupled to the motherboard via the expansion card, and the switch is configured to power on/off the power when the keyboard is coupled to the motherboard, the bracket is configured to receive a hard disk and is moveably received in the keyboard.

9. The electronic device of claim 8, wherein the keyboard further comprises a cable coupled to the main body and a connector coupled to the cable, the expansion card comprises a base body and a mounting piece located on the base body, and a socket is located on the mounting piece to engage with the connector.

10. The electronic device of claim 8, wherein the keyboard further comprises a speaker configured to play an audio document, and the speaker is located on the operating panel.

11. The electronic device of claim 8, wherein the keyboard further comprises at least one port configured to couple to a peripheral device, and the at least one port is located on the operating panel.

12. The electronic device of claim 11, wherein the at least one port is a Universal Serial Bus port or an audio port.

13. (canceled)

14. The electronic device of claim 8, wherein the keyboard further comprises a hard disk indicator, and the hard disk indicator is configured to indicate a state of the hard disk.

15. The electronic device of claim 8, wherein the keyboard further comprises a power indicator, and the power indicator is configured to indicate a state of a power supply of the electronic device.
